(19) United States
(12) Patent Application Publication
(10) Pub. No.: US 2026/0353533 A1
(43) Pub. Date: Nov. 5, 2026

(54) DRIVER CIRCUIT AND METHODS THEREOF

(71) Applicant: ams-OSRAM International GmbH, Regensburg (DE)

(72) Inventor: Michael KOLLER, Hemau (DE)

(21) Appl. No.: 19/482,237

(22) PCT Filed: Aug. 22, 2024
(86) PCT No.: PCT/EP2024/073586

§ 371 Date: Nov. 7, 2025

(30) Foreign Application Priority Data
Oct. 18, 2023 (DE) 10 2023 128 562.9

(51) Int. Cl. H05B 45/48; G09G 3/32; H05B 45/10

(52) U.S. Cl. CPC H05B 45/48; G09G 3/32; H05B 45/10; G09G 2320/0633; G09G 2320/064; G09G 2330/02

(57) ABSTRACT

The present disclosure relates to a circuit (200) including: an output terminal (208) configured to be coupled with a load; a power source (202) configured to generate current according to a current ramp, such that during a predefined time period the generated current assumes a plurality of different current values in a range of current values from a minimum current value to a maximum current value; a switch element (210) configured to selectively enable or disable a delivery of the generated current to the output terminal (208); and a control circuit (212) configured to control the switch element (210) to deliver a predefined average current value at the output terminal (208) over the predefined time period.

### TECHNICAL FIELD

The present disclosure relates generally to a driver circuit configured to implement an adapted driving scheme for powering a load, and to methods thereof (e.g., a method of powering a load according to an adapted driving scheme)

### BACKGROUND

In general, lighting fixtures and display devices are present in a wide range of technical contexts and applications, e.g. for illuminating an environment, for displaying images, and the like. For driving individual pixels in a display or an ensemble, such as the ambient light in the interior of a vehicle, there are high demands in terms of dynamic range and homogeneity. Two approaches are commonly used for driving the pixels. A first approach is based on modulation in time, preferably via pulse width modulation (PWM), where a driving current is maintained at a constant value, and the ratio between on-time and off-time is varied to create a different impression of brightness. A second approach is based on amplitude modulation, in which the current is varied for each brightness value. Combinations of the two approaches are also known, where discrete amplitude settings are combined with PWM, wherein the amplitude is controlled for the entire display rather than pixel-by-pixel. Considering the combination of the two approaches, it is challenging to create linear gradients without visible jumps in the shades. Pure current control is complex due to different operating points along the P/I characteristic and different wavelength shifts of individual light emitting diodes (LEDs) across the operating modes. There is thus a need for improvements in driving schemes for lighting fixtures and display devices, which may be of particular relevance for the further advancement of several technologies.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of the invention. In the following description, various aspects of the invention are described with reference to the following drawings, in which:

FIG. 1 shows various graphs related to a driving scheme based on pulse-width-modulation, according to various aspects;

FIG. 2A shows a circuit configured to implement an adapted driving scheme for delivering power to a load, in a schematic representation according to various aspects;

FIG. 2B shows the circuit of FIG. 2A further including a load coupled with the output terminal, in a schematic representation according to various aspects;

FIG. 3A shows an exemplary configuration of a switchable element coupled with a load including a plurality of load elements, in a schematic representation according to various aspects;

FIG. 3B shows an exemplary configuration of a switchable element coupled with a load including a plurality of light emitting elements, in a schematic representation according to various aspects;

FIG. 4A to FIG. 4E show exemplary configurations of a power ramp, according to various aspects;

FIG. 5A to FIG. 5D show various graphs illustrating the adapted driving scheme and a comparison with pulse-width modulation; and

FIG. 6 shows a schematic flow diagram of a method of powering a load, according to various aspects.

### DESCRIPTION

The following detailed description refers to the accompanying drawings that show, by way of illustration, specific details and aspects in which the invention may be practiced. These aspects are described in sufficient detail to enable those skilled in the art to practice the invention. Other aspects may be utilized and structural, logical, and electrical changes may be made without departing from the scope of the invention. The various aspects are not necessarily mutually exclusive, as some aspects may be combined with one or more other aspects to form new aspects. Various aspects are described in connection with methods and various aspects are described in connection with devices (e.g., a circuit, a switchable element, a power source, a load). However, it is understood that aspects described in connection with methods may similarly apply to the devices, and vice versa.

In general, a commonly used driving scheme for controlling the delivery of electrical energy (e.g., current or voltage) from a power supply to a load is the so-called pulse width modulation (PWM), which may be applied for controlling light emitting elements (e.g., LEDs), motors, battery chargers, solar panels, and the like. The PWM technique is based on pulsing the power supply on and off at a certain frequency and with a certain pulse width, thus allowing to control the amount of electrical energy delivered to the load over a certain period of time, illustratively the average power delivered to the load. In general, the PWM driving scheme is well known in the art. Some basic concepts are described herein to introduce aspects relevant for the present disclosure.

As an abridged overview, PWM may describe the use of a digital signal to obtain an analog result. The PWM signal may be a square wave switched between a high state (illustratively, an “on state”) and a low state (“off state”). The percentage of time in which the PWM signal is in the high state is the so-called duty cycle. By way of illustration, a PWM signal always on would have a 100% duty cycle, a PWM signal always off would have a 0% duty cycle, a PWM signal on for half of a period would have a 50% duty cycle, and so on. In addition to the duty cycle, another important parameter of a PWM signal is the frequency of the waveform, i.e. the inverse of the period, i.e. the inverse of the complete on-time and off-time of the PWM signal. By controlling the duty cycle of the PWM signal it is possible to control the electrical power perceived by a load. Illustratively, by varying the duty cycle (the relative on-time), the average voltage of the signal may vary accordingly.

A relevant use case for the PWM technique is the control of the brightness of light emitted by a light emitting diode (LED), the so-called “dimming”. With PWM, a LED is turned on and off with a duty cycle and frequency defined by the PWM signal. By varying the on-time, the brightness of the emitted light as perceived by the human eye may be varied accordingly. The frequency of the PWM signal should be sufficiently high to avoid flickering, i.e. the on/off frequency should be faster than the perception of the human eye (the so-called Flicker Fusion Rate). For LED dimming, the frequency of a PWM signal may be for example around 100 Hz.

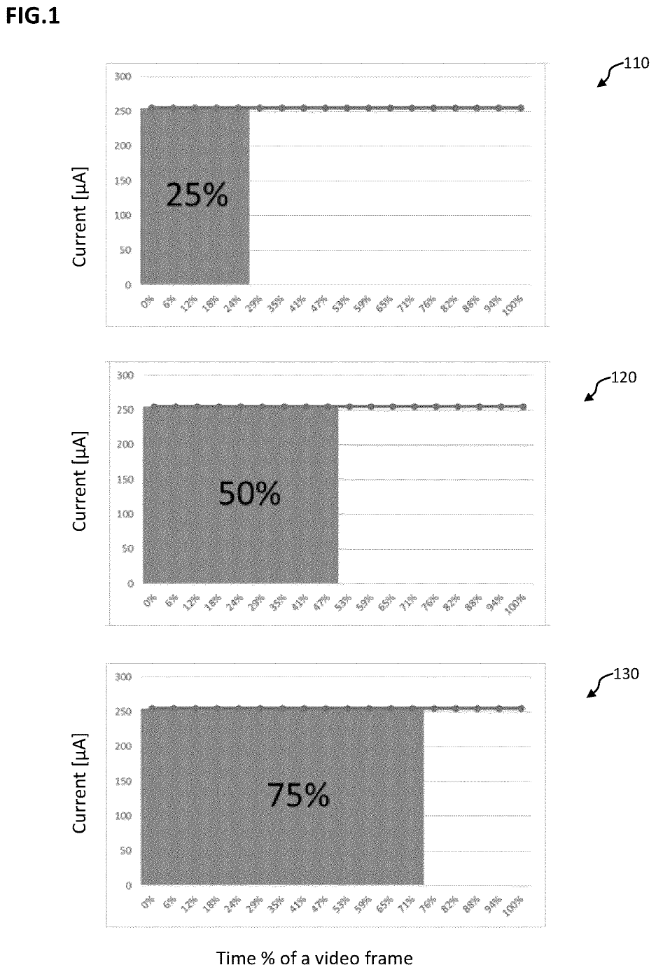

In this regard, FIG. 1 shows various graphs 110, 120, 130 illustrating the exemplary case in which PWM is used for driving a display device. The aspects described in relation to FIG. 1 may apply in a corresponding manner to the use of PWM for other applications (e.g., for controlling the speed of a motor, for controlling a fan in a computer, etc.). As mentioned, PWM may allow to control the amount of electrical energy (e.g., the amount of current) perceived by a LED over a period of time (e.g., a video frame), and accordingly the brightness of the emitted light as perceived by the human eye, by controlling the fraction of time during which the LED is on within the time period.

For example, with a 100% duty cycle, i.e. a LED always on during a frame, a maximum brightness (illustratively, 100%), is obtained. Conversely, by maintaining the LED on only for a fraction of the duration of a frame, the brightness may be reduced (illustratively, dimmed) accordingly. With reference to the graphs 110, 120, 130, with a 25% duty cycle the LED may be on for 25% of the duration of a frame (graph 110), and the 25% of the maximum achievable brightness may be obtained. With a 50% (graph 120) or 75% (graph 130) duty cycle, the LED may be on for 50% or 75% of the duration of a frame, and the 50% or 75% of the maximum achievable brightness may be obtained, etc.

Illustratively, a LED has an amount of power for which the LED produces a maximum output (e.g., light at maximum brightness). The PWM technique is based on switching the LED on and off at high frequency so that the power perceived by the LED varies in a range between 0 and the amount of power corresponding to the maximum output, thus regulating the brightness as a function of the ratio of the on-time to off-time. PWM thus provides an approach in which a current is fixed and a LED is switched on and off for “blocks” of time to obtain a change in brightness based on the length of the blocks.

PWM may thus provide a relatively simple scheme to adjust the LED's brightness. However, especially at low brightness values (corresponding to a short on-time versus long off-time), PWM has shortcomings, e.g. in relation to persistence of light on the retina. Illustratively, due to the inertia of the human eye, an optical illusion occurs, caused by rapid eye movement towards or away from a pulsed light source (e.g., a pulsed LED), for which the light source appears multiple times to the viewer.

Another approach to LED dimming is the so-called constant current reduction (CCR), in which the LED is maintained constantly on, and the current level of the current delivered to the LED is adjusted to change the brightness of the emitted light. The CCR technique provides thus an “analog dimming”, in which the amplitude of the current is increased or decreased to cause a corresponding increase or decrease in the LED's brightness. CCR may be more suitable than PWM for applications involving longer wire lengths. However, CCR is not well suited for dimming at relatively low brightness levels, e.g. below 10% of the maximum brightness.

Aspects of the present disclosure may be directed to a driving scheme for delivering electrical power from a source to a load, adapted to overcome at least some of the limitations of conventional driving methods (e.g., classic PWM, or amplitude modulation). The present disclosure may be based on the realization that aspects typical of PWM may be combined with aspects typical of amplitude modulation to obtain a driving scheme applicable in a wide dynamic range, and with improved properties at low power values (e.g., corresponding to low brightness values for a light emitting element).

Aspects of the present disclosure may be related to a driving scheme including a pulsed delivery of electrical power from a source to a load, and in which the power generated by the power source is not constant over time, as in a classic PWM scheme, but rather varies according to a ramp. The variation over time of the electrical power generated by the power source introduces an additional degree of control for driving the load. Illustratively, the driving scheme proposed in the present disclosure may be a combination of amplitude modulation, for which the amplitude of the generated power varies over time, with pulse width modulation, for which a “pulsing” of the power delivery is implemented.

According to the proposed driving scheme, the amount of electrical power delivered to the load may thus be controlled not only by selecting the fraction of “on-time” (e.g., during a frame of a display device), but additionally by selecting at which time points the delivery of power should be enabled, because different time points correspond to different amplitudes. The proposed driving scheme enables thus a finer and more flexible control of the power delivery to the load, while maintaining an overall simple architecture.

The proposed strategy may be illustratively described from two different perspectives. As a first illustrative description, according to the proposed approach a switchable element is used to selectively enable or disable the delivery of power to the load, e.g. by selectively connecting or disconnecting an electrically conductive path from the power source to the load. As a second illustrative description, according to the proposed approach power that varies according to a ramp is delivered to the load, and the load is selectively turned on and off, thus providing a pulsed powering of the load with the power delivered at the time points at which the load is “on”.

According to various aspects, a circuit may include: an output terminal configured to be coupled with a load; a power source configured to generate electrical power according to a power ramp, such that during a predefined time period the generated electrical power assumes a plurality of different power values in a range of power values from a minimum power value to a maximum power value; a switchable element configured to selectively enable or disable a delivery of the generated electrical power to the output terminal (and, accordingly, to a load coupled with the output terminal); and a control circuit configured to control the switchable element to provide a predefined average power value at the output terminal over the predefined time period.

According to various aspects, a circuit may include: a power source configured to generate electrical power according to a power ramp and to deliver the generated electrical power to a load, such that during a predefined time period the power delivered to the load assumes a plurality of different power values in a range of power values from a minimum power value to a maximum power value; and a control circuit configured to turn the load on and off during the predefined time period according to an average power value to be perceived by the load during the predefined time period.

The proposed approach has the advantage of a significantly higher dynamic range and at the same time reduced effort for amplitude modulation. For example, for controlling the brightness of emitted light, e.g. in a display, the proposed strategy may be implemented using a centralized power supply, and controlling the switching at the pixel level, rather than controlling the current level pixel by pixel.

In the proposed strategy, for each frame (e.g. with a frame rate of 50 Hz (20 ms), 100 Hz (10 ms), 200 Hz (5 ms), as examples) a defined current ramp may be generated and switched to the load (e.g., a light emitting element, e.g. a LED). With a current ramp the same integrals may be provided as with a classical PWM. The proposed approach allows however to resolve significantly smaller brightness values compared to PWM, considering the exemplary application of driving a light emitting element. While with classical PWM the sequence of on/off blocks within an image has no significant influence on the brightness perception, with the proposed ramp in combination with switching a 2ⁿ brightness gradation may be achieved, where “n” is the number of current values within the ramp, depending on which parts of the ramp are combined within an image.

A relevant use case of the proposed driving scheme may be the dimming of light emitting elements (e.g., LEDs), because the adapted driving scheme allows a fine control of the brightness of the emitted light, and thus provides a particularly advantageous solution for creating illumination patterns. Thus, in the following particular reference may be made to the use of the adapted driving scheme with a ramp and a switching for driving light emitting elements, e.g. LEDs. It is however understood that the applications of the adapted driving scheme described herein are not limited to brightness control, and may in general be applied for powering any suitable load for which a fine tuning of the delivered power may improve the operation of the load. As other examples, the adapted driving scheme may be implemented for driving a motor, a battery charger, a fan of a computer, and the like.

In general, for controlling a LED to emit light it may be preferable to control the current delivered to the LED rather than the voltage applied to the LED, because for a LED small variations in the voltage may cause large variations in the current conducted through the LED. It may thus be difficult to precisely control the LED's behavior relying on the voltage. Thus, in the present disclosure, particular reference may be made to the generation of current according to a current ramp for implementing the proposed driving scheme. Illustratively, particular reference may be made to a configuration in which the power delivered to the load varies according to a ramp by varying a generated current according to a current ramp. It is however understood that the aspects described herein in relation to a current ramp or to a power source configured to generate current according to a current ramp may apply in a corresponding manner to a voltage ramp or to a power source configured to generate voltage according to a voltage ramp, and vice versa. For example, a voltage ramp may be used for driving cells of a Liquid Crystal Display (LCD) device.

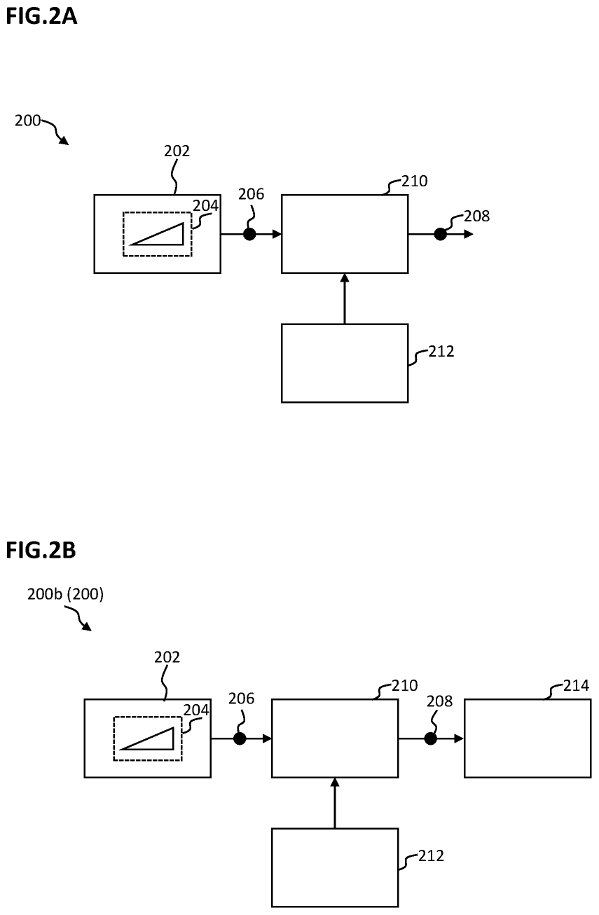

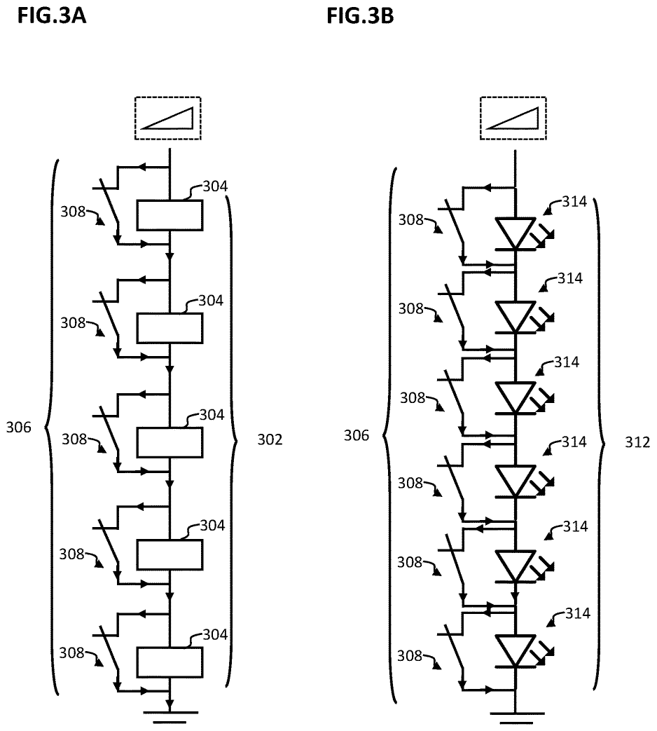

FIG. 2A and FIG. 2B show a circuit 200 configured to implement an adapted driving scheme for delivering power to a load, in a schematic representation according to various aspects. FIG. 2B shows a further configuration 200b of the circuit 200 of FIG. 2A.

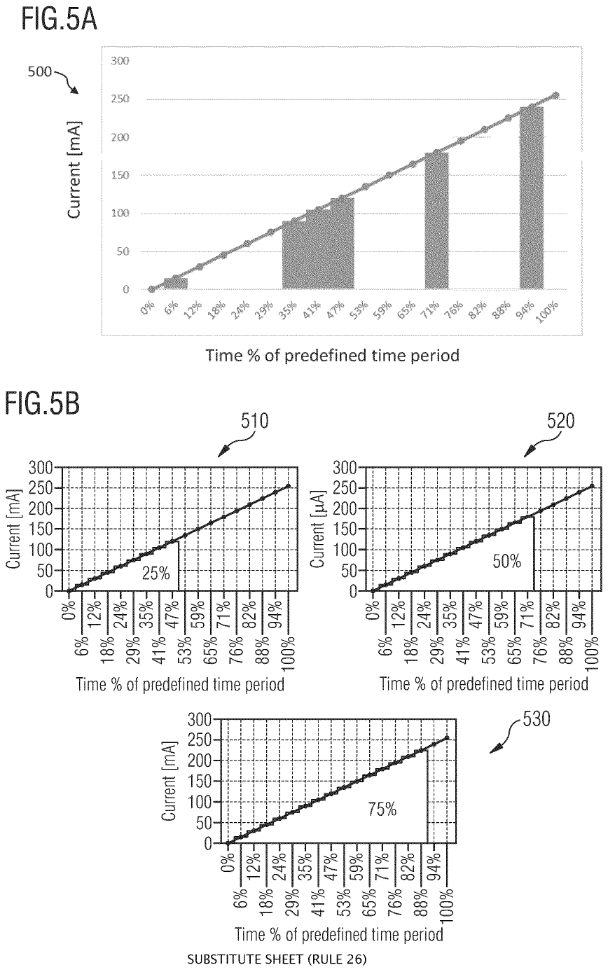

The circuit 200 may include a power source 202 configured to generate electrical power according to a power ramp 204 (see also FIG. 4A to FIG. 4E). Illustratively, the power source 202 may be configured to provide (e.g., deliver) to a supply terminal 206 an electrical power that has over a predefined time period a behavior defined by a power ramp 204. Stated differently, the power source 202 may be configured to provide (e.g., to ramp) the electrical power at the supply terminal 206 over the predefined time period according to a predefined ramp behavior. During the predefined time period, the generated electrical power may thus be a continuous power that assumes different values according to the power ramp 204. In the following, “electrical power” may be referred to simply as “power”.

In a preferred configuration, the power source 202 may be configured to generate current according to a current ramp, e.g. the power source 202 may be configured to provide (e.g., to supply) at the supply terminal 206 a current that has over the predefined time period a behavior defined by a current ramp. For example, during the predefined time period the generated current may assume a plurality of different current values in a range from a minimum current value to a maximum current value according to a behavior defined by the current ramp. In this scenario, the power source 202 may thus be a constant current source that generates a continuous current that varies during the predefined time period according to a current ramp.

In other aspects, the power source 202 may be configured to generate voltage according to a voltage ramp, e.g. the power source 202 may be configured to provide (e.g., to supply) at the supply terminal 206 a voltage that has over the predefined time period a behavior defined by a voltage ramp. In this configuration, during the predefined time period the generated voltage may assume a plurality of different voltage values in a range from a minimum voltage value to a maximum voltage value according to a behavior defined by the voltage ramp. In this scenario, the power source 202 may thus be a constant voltage source that generates a continuous voltage that varies during the predefined time period according to a voltage ramp.

In the following, aspects of the operation of power source 202 may be described with reference to generated current and to a current ramp, but it is understood that such aspects apply in a corresponding manner to a generated voltage and a voltage ramp.

In general, there may be various implementations for a power source 202 configured to generate power according to a ramp 204, e.g. for a power source configured to generate current according to a current ramp or voltage according to a voltage ramp, and any suitable configuration may be used so that a detailed explanation in this regard is dispensed with. Only as an exemplary realization, the power source 202 may include a signal generator configured to generate a ramp signal (illustratively, a sawtooth signal) by charging a capacitor with constant current and by discharging the capacitor via a transistor when a certain voltage is reached. In this exemplary realization, the power source 202 may thus include a capacitor, a voltage source defining a voltage drop across the capacitor, one or more resistors (e.g., with at least one resistor coupled in series with the capacitor), and a transistor to control the discharge of the capacitor.

In general, the power source 202 may further include an output stage that maintains the properties of the generated signal (e.g., the generated power) independently of the switching on or off of the load in fast mode. The output stage may be fed with arbitrary signal forms (e.g., the ON segments of the sawtooth directly), or may generate a clean triangle or sawtooth signal (e.g., a triangular or sawtooth current) that may be switched by an external circuit. As an exemplary realization, commercially available tabletop equipment may be used for this purpose. In a more complex realization, the output stage may be realized via a suitably configured application-specific integrated circuit (ASIC) or driver integrated circuit.

The term “ramp” may be used herein to indicate that the power generated by the power source 202 has an initial value (or start value) at the beginning of the predefined time period (also referred to as time point tr) and varies throughout the predefined time period to reach a final value (or end value) at the end of the predefined time period (also referred to as time point t_{F}). The behavior (illustratively, the profile) of the ramp within the predefined time period may be adapted to define how the power varies from the initial value to the final value. The term “ramp” is therefore not limited to a linear variation from the initial value to the final value, but is used herein to encompass any suitable waveform for the power ramp 204 (e.g., for the current ramp, or the voltage ramp) in the predefined time period, as will be described in further detail in relation to FIG. 4A to FIG. 4E. Furthermore, the term “ramp” is not limited to a variation from a minimum value to a maximum value, but is used herein to encompass any suitable initial value and any suitable final value, as will be described in further detail in relation to FIG. 4A to FIG. 4E.

The power source 202 may be configured to generate power according to the ramp 204 in a periodic manner or in an aperiodic manner. Illustratively, the power source 202 may be configured to generate power according to the ramp 204 in a plurality of instances of the predefined time period. For example, the power source 202 may be configured to generate power according to the ramp 204 in a first instance of the predefined time period, to further generate power according to the ramp 204 in a second instance of the predefined time period, to further generate power according to the ramp 204 in a third instance of the predefined time period, etc. In general, each instance of the predefined time period may have the same duration, illustratively the same length. In some aspects, however, the duration of the predefined time period over which the ramp is provided may vary in different instances.

In general, the instances of the predefined time period may be periodically or aperiodically spaced in time. Illustratively, after an instance of the predefined time period is terminated (and the power reached the final value), a subsequent instance may start (from the initial value), after the subsequent instance is terminated a further subsequent instance may start, etc. In a preferred configuration, a time interval between consecutive instances of the predefined time period may be equal throughout the plurality of instances, thus providing a periodic operation of the power source 202. In some aspects, however, the time interval between consecutive instances of the predefined time period may vary throughout the plurality of instances, e.g. to adapt the driving scheme to specific requirements of a certain appliance.

In a preferred configuration, the behavior of the power source 202 may remain the same throughout the plurality of instances of the predefined time period. Illustratively, the power source 202 may generate power according to the same ramp 204 in each instance of the predefined time period, e.g. starting from the same initial value, terminating at the same final value, with the same ramp profile, etc. This may ensure a more reproducible and predictable driving of the load.

It is however understood that, in principle, one or more parameters of the power generation may be varied throughout the plurality of instances of the predefined time period. For example, one or more of the initial value, final value, and/or ramp profile may vary from one instance of the predefined time period to another instance of the predefined time period. As an example, in a first instance of the predefined time period the power source 202 may generate power from a first initial value to a first final value and with a first ramp profile. In a second instance of the predefined time period the power source 202 may generate power from a second initial value to a second final value and with a second ramp profile. In this configuration, the first initial value may be different from the second initial value, and/or the first final value may be different from the second final value, and/or the first ramp profile may be different from the second ramp profile. The same may apply to a third instance of the predefined time period, etc.

According to various aspects, the circuit 200 may further include an output terminal 208 configured to be coupled with a load, e.g. an active load driven by the power provided by the power source 202. In various aspects, as shown for the configuration in FIG. 2B, the circuit 200b may further include a load 214 coupled with the output terminal 208. The output terminal 208 may be electrically conductively connected with the power source 202, e.g. with the supply terminal 206, so that the power generated by the power source 202 may be delivered to the output terminal 208, and to the load 214. For example, the current generated by the power source 202 may be delivered to the output terminal 208, so that the current flowing through the output terminal 208 (towards the load 214) may vary according to a current ramp. As another example, the voltage generated by the power source 202 may be delivered to the output terminal 208, so that the voltage at the output terminal 208 (and across the load 214) may vary according to the voltage ramp. Although not shown, the load 214 may be further connected to a reference potential, e.g. to ground.

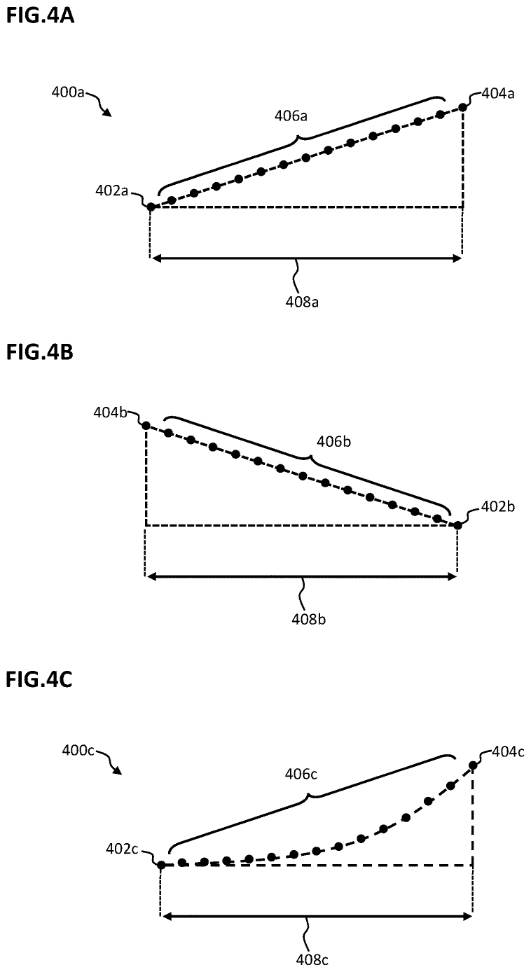

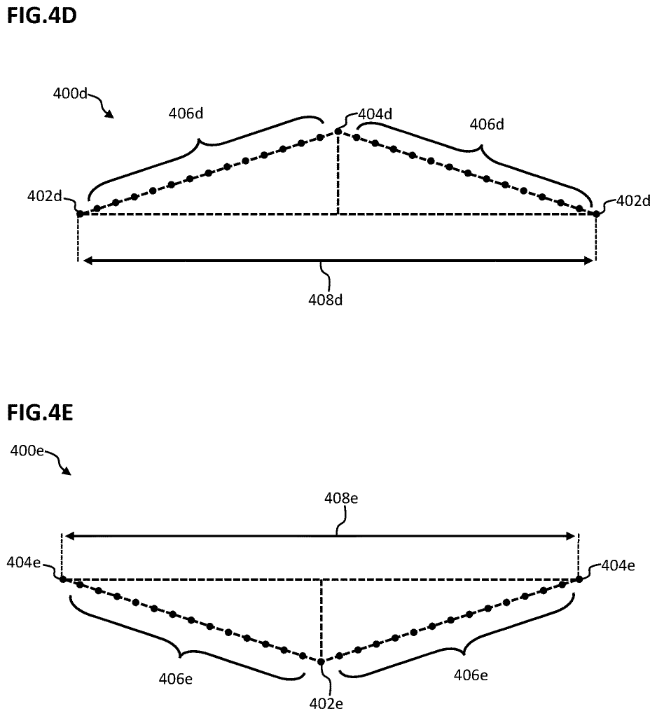

The load 214 may be any suitable electrical device or electrical component that may be driven according to the proposed driving scheme. In a preferred configuration (see also FIG. 3B) the load 214 may include one or more light emitting elements, e.g. a plurality of light emitting elements, for example a plurality of LEDs. As an example, the load 214 may be a display device including a plurality of pixels, and each pixel may include a corresponding light emitting element (e.g., a corresponding LED). As mentioned, the proposed driving scheme may be particularly suitable for adjusting the brightness level of emitted light with a fine resolution. In other aspects, the light emitting elements of the load 214 may include one or more laser sources, e.g. a plurality of laser sources. For example, the light emitting elements may include one or more vertical-cavity surface-emitting laser (VCSEL) devices or edge emitting laser devices. As an example, the load 214 may include a VCSEL array. The application of the proposed strategy to driving a laser source may be based on the realization that in some application scenarios, e.g. in a “flying spot” scanner, the issues of conventional PWM may be even more relevant than for a LED array. It is however understood that, in principle, the load 214 may include also other types of electrically driven devices or components. As other examples, the load 214 may include a motor, a fan, a battery charger circuit, a solar cell, and the like.

Considering the configuration in which the load 214 includes a display device, the predefined time period may correspond to a frame period of the display device, illustratively to a video frame. In this scenario, the duration of the predefined time period may be adapted according to the frame rate of the display device. For example, for a 50 Hz frame rate, the predefined time period may have a duration of 20 ms, for a 100 Hz frame rate the predefined time period may have a duration of 10 ms, etc.

According to various aspects, the circuit 200 may further include a switchable element 210 configured to selectively enable or disable the delivery of the power generated by the power source 202 to the output terminal 208, for example the delivery of the generated current or generated voltage. Stated in a different fashion, the switchable element 210 may be configured to selectively enable or disable the powering of the load 214 by the power generated by the power source 202, e.g. a driving of the load 214 via the current/voltage generated by the power source 202. A switchable element (e.g., the switchable element 210) may also be referred to herein as switch element or coupling element.

In the exemplary representation in FIG. 2A and FIG. 2B, the output terminal 208 and switchable element 210 are shown as external to the power source 202. It is understood that the output terminal 208 and switchable element 210 may also be considered part of the power source 202, e.g. may be part of a power source device including the power source 202, the output terminal 208, and the switchable element 210.

As an exemplary configuration, the switchable element 210 may be configured (e.g., controllable) to selectively assume one of a plurality of possible states. In an exemplary configuration, the switchable element 210 may have a (first) state in which the switchable element 210 allows the power from the power source 202 to reach the output terminal 208 (and the load 214), and a (second) state in which the switchable element 210 prevents the power from the power source 202 to reach the output terminal 208 (and the load 214). For example, in the first state the switchable element 210 may connect the output terminal 208 with the power source 202, and in the second state the switchable element 210 may disconnect the output terminal 208 from the power source 202.

There may be various ways to realize the selective enabling/disabling of the power delivery. As an example, the switchable element 210 may be configured to selectively connect or disconnect an electrically conductive path between the power source 202 and the load 214. The electrically conductive path may be between the power source 202 and the output terminal 208, or between the output terminal 208 and the load. Illustratively, the switchable element 210 may be controlled to close the path and allow power to reach the load 214, or may be controlled to open the path and prevent power from reaching the load 214.

As another example, the switchable element 210 may be configured to selectively connect an electrically conductive path that bypasses the load 214. Illustratively, the switchable element 210 may be controlled to close a low resistance path so that current flows through the low resistance path bypassing the load 214, or may be controlled to open the low resistance path so that the current flows through the load 214. The low resistance path may be an electrically conductive with a lower resistance compared to the load 214, so that closing the switchable element 210 may short circuit the load 214.

As an exemplary implementation, the switchable element 210 may include a transistor, e.g. a Metal Oxide Semiconductor (MOS) transistor such as an NMOS or PMOS, a Field Effect Transistor (FET), a MOSFET, a Bipolar Junction Transistor (BJT), and the like. It is however understood that the switchable element 210 may be realized in any suitable manner, e.g. as a single element or as a combination of elements to achieve the switching of the power delivery.

The circuit 200 may further include a control circuit 212 configured to control the switchable element 210. In general, the control circuit 212 may be configured to control the switchable element 210 to deliver an average power (e.g., an average current, or average voltage) to the load 214 over the predefined time period (e.g., over each instance of the predefined time period). Illustratively, the control circuit 212 may be configured to control the switchable element 210 such that the load 214 perceives an average power over the predefined time period, e.g. such that the load 214 perceives an average current over the predefined time period.

Considering the configuration in FIG. 2A, the control circuit 212 may be configured to control the switchable element 210 to deliver a predefined average power at the output terminal 208 over the predefined time period, e.g. a predefined average current or a predefined average voltage. Illustratively, the control circuit 212 may control the switchable element 210 such that a current at the output terminal 208 may have a predefined average current value when averaging the current values at the output terminal 208 over the predefined time period. The same may apply for an average voltage value. Considering a plurality of instances of the predefined time period, the control circuit 212 may be configured to control the switchable element 210 in each instance to deliver a predefined average power at the output terminal 208 over that instance of the predefined time period.

By way of illustration, the strategy proposed herein may thus include a power source 202 generating power according to a ramp, and a switching of the power delivery. The delivered power may thus be defined by the combination of the power values at the time points at which the power delivery is enabled. The power delivery and the corresponding powering of the load 214 may be controlled with a finer resolution compared to a classical PWM by the synchronization of the timing of the enabling/disabling (as first control “knob”) with the ramp profile (as second control “knob”) to select which power values to use and enable a more flexible adaptation of the power perceived by the load 214.

In some aspects, the control circuit 212 may be configured to control the switchable element 210 based on a desired operation of the load 214. Illustratively, the delivery of a certain average power to the load 214 over the predefined time period may correspond to a certain behavior of the load 214. The control circuit 212 may be configured to control the switchable element 210 to obtain a predefined behavior of the load 214 as a function of the average power (e.g., average current) perceived by the load 214 over the predefined time period.

Considering the exemplary configuration in which the load 214 includes one or more light emitting elements, the control circuit 212 may be configured to control the switchable element 210 based on a target brightness level of the light emitted by the one or more light emitting elements during the predefined time period (or during one or more instances of the predefined time period). The target brightness level may be a brightness level to be obtained, for example during a video frame of a display device.

The control circuit 212 may thus be configured to generate a control signal and use the control signal to control the behavior of the switchable element 210. For example, considering a transistor as switchable element, the control signal may be a gate signal that the control circuit 212 provides at the gate terminal of the transistor to control the electrical behavior of the channel. The control signal may be configured in accordance (e.g., in synchronization) with the ramp 204. Illustratively, the power varying according to the ramp 204 may assume a plurality of power values over the predefined time period, and the control signal may be configured to control the switchable element 210 to enable the delivery of power in correspondence of the power values that result in the average power value to be delivered at the output terminal 208 (and to the load 214).

For example, the control signal may include a plurality of pulses in correspondence of the time points at which the generated power assumes the power values that result in the average power to be perceived by the load 214 over the predefined time period. Stated differently, the control signal may be in a first state (e.g., a high state) in which the control signal controls the switchable element 210 to enable the power delivery, and in a second state (e.g., a low state) in which the control signal controls the switchable element 210 to disable the power delivery. The control signal may be in the first state in correspondence of the time points at which the generated power assumes the power values that result in the average power to be perceived by the load 214 over the predefined time period. The same may apply in terms of an average current, or average voltage, to be perceived by the load 214 over the predefined time period. The control signal may thus be timed with the amplitude of the generated power, e.g. with the amplitude of the generated current or voltage.

As seen from another standpoint, the pulsed powering of the load 214 may be implemented by controlling an activation and deactivation of the load 214 during the predefined time period over which the power source 202 generates power according to the ramp 204. Illustratively, according to the proposed approach the power source 202 may be configured to deliver the generated power to the load 214, and the control circuit 212 may be configured to selectively turn the load 214 on and off during the predefined time period according to an average power value to be perceived by the load 214. Illustratively, the control signal generated by the control circuit 212 to control the switchable element 210 may be understood as a control signal to activate/deactivate the load 214 in accordance (e.g., in synchronization) with the ramp 204 (e.g., with the current ramp, or voltage ramp).

According to various aspects, the proposed approach may be combined with other methods for supplying power to the load 214. For example, the proposed approach may be combined with conventional PWM, or with conventional amplitude modulation, to provide a more flexible configuration and provide more options to adapt the driving scheme. For example, conventional PWM may be used to deliver overall higher power to the load, e.g. to obtain higher brightness of emitted light.

According to various aspects, the circuit 200 may include, in addition to the power source 202, a further power source (not shown) to implement conventional PWM (e.g., a further current source, or a further voltage source). The further power source may be configured to generate a current having a fixed current value, or a voltage having a fixed voltage value, rather than according to a ramp. For example, during the predefined time period the power source 202 may generate current according to a current ramp, and the further power source may generate a current having a fixed current value. The circuit 200 may further include a further switchable element configured to selectively enable or disable a delivery of the current with the fixed current value at the output terminal 208, e.g. to the load 214. The control circuit 212 may be further configured to control the further switchable element to provide a further average current value at the output terminal 208. The further power source may be operated in combination with the power source 202 or independently from the power source 202.

According to various aspects, as shown in FIG. 3A and FIG. 3B, the switchable element 210 may include a plurality of switchable elements to individually enable or disable the power delivery to a plurality of load elements. Illustratively, FIG. 3A shows a load 302 with a plurality of load elements 304, as an exemplary configuration of the load 214, and a switchable element 306 with a plurality of switchable elements 308, as an exemplary configuration of the switchable element 210. FIG. 3B shows the exemplary case in which a load 312 includes a plurality of light emitting elements 314 (e.g. a plurality of LEDs such as MicroLEDs, a plurality of VCSELs, etc.) as plurality of load elements.

In an exemplary configuration, the load 302 may include a plurality of load elements 304 which may be individually driven with the pulsed power. In this scenario, the switchable element 306 may be configured to allow an individual enabling or disabling of the delivery of power to the load elements 304. The switchable element 306 may thus include a plurality of switchable elements 308, e.g. a plurality of transistors, each associated with one or more of the load elements 304. For example, there may be a one-to-one correspondence between the switchable elements 308 and the load elements 304 (as in FIG. 3A). As another example, there may be a one-to-many correspondence between the switchable elements 308 and the load elements 304, in which one switchable element 308 controls the selective enabling or disabling of the delivery of power to more than one load element 304.

In the exemplary configuration in FIG. 3A, the switchable elements 308 are configured to selectively allow a current flow through the associated load element 304 or to close a low resistance path to cause the current flow to bypass the associated load element 304. It is however understood that the aspects discussed in relation to the exemplary configuration of FIG. 3A apply in a corresponding manner to other configurations of the switchable elements 308, e.g. in a configuration in which a switchable element 308 electrically connects or disconnects an electrically conductive path for the delivery of current to the associated load element(s).

In a preferred configuration, the plurality of load elements 304 may be connected in series to one another. In this scenario, the switchable elements 308 may be configured as “bypass switches” as shown in FIG. 3A and FIG. 3B to either allow current flow through the corresponding load element 304 or provide a low resistance path for bypassing the load element 304. Considering a set of LEDs (FIG. 3B), e.g. of LED pixels, every LED may have an associated switchable element 308 able to short circuit the LED (and bypass it) to keep the circuit closed but that individual LED dark. By opening that switch the current flows through the LED make it light up. In this configuration, the current flow through the series of load elements 304, e.g. the series of LEDs, may remain constant independently of whether a load element is active or inactive, e.g. independently of whether a LED emits light. If a load element 304 is inactive (e.g., no light emitted) the voltage of the shorted load element 304 is close to 0, and thus the power in this case is close to 0. This configuration provides thus a power-efficient system.

A further advantage of the proposed driving scheme is that a single power source (e.g., the power source 202) may be used to individually drive a plurality of load elements 304, simply providing a corresponding switchable element 308 for each load element 304, rather than providing a plurality of power sources. Illustratively, in various aspects, the power source providing the power ramp may be common to all load elements 304. For example, the power source providing a current ramp may be common to all light emitting elements, e.g. all LEDs, of the plurality of light emitting elements 312. Considering a display device, a common power source may be used to power all the pixels of the display device. In another configuration, a common power source may be used to power a subset of pixels, for example a row of pixels, a column of pixels, a quadrant of pixels, and the like.

Considering a configuration with a plurality of switchable elements 308, a control circuit (e.g., the control circuit 212) may be configured to individually control the switchable elements 308. Illustratively, the control circuit may be configured to control a switchable element to deliver a respective predefined average power value to the respective load element 304 (or plurality of load elements 304) over the predefined time period. For example, the control circuit may be configured to control a switchable element to have the respective load element(s) perceive a predefined average current (or voltage) over the predefined time period.

As mentioned in relation to FIG. 2A and FIG. 2B, the ramp according to which the power source generates power may be adapted in various ways, e.g. with certain maximum and minimum values, with a certain profile, with a certain duration, etc. In principle, the ramp may assume any suitable form depending on the characteristics of the load to be powered and on the desired operation of the load. In the following, some exemplary configurations for the ramp will be discussed.

FIG. 4A to FIG. 4E show exemplary configurations of a power ramp 400a-400e, according to various aspects. It is understood that the aspects discussed in relation to FIG. 4A to FIG. 4E may apply in a corresponding manner to a current ramp or voltage ramp. By way of illustration, FIG. 4A to FIG. 4E show exemplary realizations of the power ramp 204 according to which the power source 202 generates power. Some general properties of a power ramp 400a-400e will be introduced, and then specific exemplary characteristics will be described in relation to the illustrated examples.

In general, considering a power ramp 400a-400e the power values may vary over the predefined time period 408a-408e in a range of power values delimited by a minimum power value 402a-402e and a maximum power value 404a-404e. Considering a current/voltage ramp, the generated current/voltage may vary in a range of a current/voltage values between a minimum a current/voltage value and a maximum a current/voltage value.

In this regard, power generated according to a power ramp 400a-400e may assume, during the predefined time period 408a-408e a plurality of power values that include the minimum power value 402a-402e, the maximum power value 404a-404e, and one or more intermediate power values 406a-406e between the minimum power value 402a-402e and the maximum power value 404a-404e. Considering a current/voltage ramp, the generated current/voltage may assume, during the predefined time period 408a-408e a plurality of current/voltage values that include the minimum current/voltage value, the maximum current/voltage value, and one or more intermediate current/voltage values between the minimum current/voltage value and the maximum current/voltage value.

The duration of the predefined time period 408a-408e (e.g., in at least one instance, in more than one instance, in each instance) may be selected depending on the intended application of the driving scheme, e.g. on the intended operation of the load to be driven. As a numerical example, which may be relevant for controlling brightness of emitted light, the predefined time period 408a-408e may have a duration in the range from 1 ms (milliseconds) to 1 s, for example a duration in the range from 5 ms to 500 ms, for example a duration in the range from 10 ms to 100 ms. As mentioned, in some aspects, the predefined time period 408a-408e may have a duration corresponding to the duration of a video frame of a display device in which a circuit as configured herein is integrated to drive the pixels of the display device. It is however understood that the predefined time period 408a-408e may have any suitable duration depending on the application.

In a corresponding manner, the power values of the power ramp 400a-400e may be adapted depending on the load to be driven. For example, considering a current ramp, the current values may be in the range from 0 mA to 1 A, for example in the range from 10 mA to 500 mA, for example in the range from 50 mA to 300 mA. As another example, considering a voltage ramp, the voltage values may be in the range from 0 V to 20 V, for example in the range from 1 V to 10 V, for example in the range from 2 V to 5 V.

According to various aspects, one or more power values, e.g. at least the maximum power value 404a-404e, may be greater than a rated nominal power for powering the load. For example, considering light emitting elements, one or more power values may be greater than the maximum power rater for the light emitting elements. As an example, at least one current value may be greater than the maximum driving current rated for a light emitting element, e.g. for a LED. This may ensure that a sufficient average power is perceived by the load, also taking into consideration the relatively low power values that the ramp may include.

In this scenario, the control circuit 212 may be configured to allow the delivery of power to the load in correspondence of at least one power value (e.g., a plurality of power values) greater than the rated nominal power for powering the load, e.g. in correspondence of at least one current value greater than the rated nominal current or nominal voltage for operating the load. Illustratively, in some aspects the power ramp 402a-402e and the control circuit 212 may be configured to enable an over-current (or over-voltage) operation of the load. This type of operation may allow obtaining, for example, a higher brightness, while remaining with the allowed thermal stress range for the load. By way of illustration, in a conventional PWM the fixed value for the current or voltage may be equal to or less than the nominal rated current/voltage for the load. In the proposed scheme one or more power values of the power ramp 402a-402e delivered to the output terminal (and the load) during the predefined time period may exceed the nominal rated specification of the load, to balance the overall effective power perceived by the load considering the lower values present in the range defined by the ramp.

As shown in FIG. 4A to FIG. 4E, the predefined time period 408a-408 may be subdivided into a plurality of time intervals, and the power ramp 402a-402e may be configured such that during each time interval the power assumes a respective power value (within the range), e.g. during each time interval the current/voltage assumes a respective current/voltage value. The power ramp 402a-402e may have a “staircase-like” behavior, in which the power assumes and remains at a respective power value during each time interval. As another example, the power ramp 402a-402e may have a “pulse-like” behavior, in which the power ramp includes a plurality of pulses each with a respective power value.

The number of power values, and accordingly the number/duration of the time intervals, may be adapted according to a desired granularity for the power delivery. With the proposed approach, it may be possible to resolve lower power values (e.g., lower current values and accordingly lower brightness values) compared to conventional driving schemes such as PWM. In turn, this may allow to obtain a lower minimum brightness value for light emission, or to have in combination with several on/off steps a high resolution for high dynamic range brightness level, considering the exemplary application for driving light emission. The granularity of the power ramp may thus be selected according to a desired resolution for the power delivery. As a numerical example, a time interval into which the predefined time period 408a-408e is subdivided may have a duration in the range from 1 μs (microsecond) to 1 ms, for example in the range from 10 μs to 500 μs, for example in the range from 50 μs to 200 μs. In a corresponding manner the number of power values assumed by the generated power over the predefined time period 408a-408e may be in the range from 3 to 100000, for example in the range from 50 to 10000, for example in the range from 100 to 1000.

As discussed in relation to FIG. 2A, to implement the proposed scheme, the control circuit 212 may be configured to enable the power delivery during one or more of the time intervals, to select which power values contribute to the average over the predefined time period 408a-408e. Illustratively, the control circuit may be configured to control the switchable element to enable the delivery of power (e.g., the delivery of current) during one or more first time intervals and to disable the delivery of power during one or more second time intervals according to the average power value to be perceived by the load.

According to various aspects, the minimum power value 402a-402e of the ramp 400a-400e may be greater than 0 W. For example, the minimum current value may be greater than 0 A, or the minimum voltage value may be greater than 0 V. This configuration may be provided to adapt the delivered power to the requirements of the load, e.g. in case very small power values would not sufficiently contribute to the operation of the load. As an exemplary realization, the circuit proposed herein may include a bias power source configured to generate a bias power defining the minimum power value greater than 0 W. For example, the circuit may include a bias current source configured to generate a bias current.

In general, the power ramp 400a-400e may be configured such that the power values vary in a monotonic manner during the predefined time period 408a-408e. For example, as shown in FIG. 4A and FIG. 4C, the power ramp 400a, 400c may go from the minimum power value 402a, 402c to the maximum power value 404a, 404c. Illustratively, the power ramp 400a, 400c may be configured such that the power values increase from the minimum power value 402a, 402c to the maximum power value 404a, 404c over the predefined time period 408a, 408c, e.g. a current/voltage ramp may be configured such that the current/voltage values increase from the minimum current/voltage value to the maximum current/voltage value over the predefined time period 408a, 408c. This configuration may be referred to as ramp-up.

As another example, as shown in FIG. 4B, the power ramp 400b may go from the maximum power value 404b to the minimum power value 402b. Illustratively, the power ramp 400b may be configured such that the power values decrease from the maximum power value 404b to the minimum power value 402b over the predefined time period 408b, e.g. a current/voltage ramp may be configured such that the current/voltage values decrease from the maximum current/voltage value to the minimum current/voltage value over the predefined time period 408b. This configuration may be referred to as ramp-down, and may be easier to implement than ramp-up in some scenarios.

As a further example, as shown in FIG. 4D and FIG. 4E, a combination of ramp-up and ramp-down may be provided. This configuration may provide a more complex profile to implement a more tailored control for some applications. In this configuration, for example the power ramp 400d may go from the minimum power value 402d to the maximum power value 404d and then go back to the minimum power value 402d (or to a further power value less than the maximum power value 404d). Illustratively, the power may increase from the minimum power value 402d to the maximum power value 404d (in a first portion, e.g. a first half, of the predefined time period 408d) and then decrease from the maximum power value 404d to the minimum power value 402d (in a second portion, e.g. a second half, of the predefined time period 408d).

As another example, the power ramp 400e may go from the maximum power value 404e to the minimum power value 402e and then go back to the maximum power value 404e (or to a further power value greater than the minimum power value 402e). Illustratively, the power may decrease from the maximum power value 404e to the minimum power value 402e (in a first portion, e.g. a first half, of the predefined time period 408e) and then increase from the minimum power value 402e to the maximum power value 404 (in a second portion, e.g. a second half, of the predefined time period 408e).

As mentioned, a power ramp 400a-400e may have any suitable profile. The power values may thus vary according to any suitable behavior within the range of power values. In a simple configuration, as shown in FIG. 4A and FIG. 4B, the power ramp 400a, 400b may be configured such that the power values vary linearly within the range of power values. As another example, as shown in FIG. 4C, the power ramp 400c may be configured such that the power values vary according to an exponential profile within the range of power values (according to a ramp-up as shown, or ramp-down, not shown). As further examples, a power ramp may be configured such that the power values vary according to a parabolic profile, according to a logarithmic profile, or any other suitable behavior. Considering a current/voltage ramp, the current/voltage values may thus vary linearly, or according to an exponential profile, a parabolic profile, a logarithmic profile, etc.

Considering the combined ramp-up/ramp-down configuration, the power ramp 400d, 400e may be configured such that the power values vary with the same profile in both portions of the predefined time period 408d, 408e, e.g. a linear profile as shown in FIG. 4D and FIG. 4E or another suitable profile. In some aspects, different profiles for the ramp-up and ramp-down may be selected, e.g. to adapt to a specific requirement of the load. For example, the power ramp 400d, 400e may be configured such that the power values vary (e.g., increase or decrease) with a first profile in the first portion of the predefined time period 408d, 408e, and vary (e.g., decrease or increase) with a second profile in the second portion of the predefined time period 408d, 408e. The first profile may be different from the second profile, e.g. the first profile may be linear and the second profile may be parabolic, or vice versa, or may be configured according to any other suitable combination.

In general, a steepness of the power ramp 400a-400e may remain constant over the predefined time period 408a-408e. Illustratively, a relative difference between consecutive power values in the power ramp 400a-400e may be equal throughout the plurality of power values forming the power ramp 400a-400e. Consecutive power values may be power values in consecutive time intervals of the predefined time period 408a-408e.

In some aspects, however, the steepness of the power ramp 400a-400e may vary over the predefined time period 408a-408e. For example, the power ramp 400a-400e may be less steep in correspondence of lower power values to provide a finer granularity for driving the load at low powers, and may be steeper in correspondence of greater power values where the granularity may be less relevant. It is however understood that the steepness of the power ramp 400a-400e may be adapted depending on the response of the load to the provided power.

A power ramp 400a-400e may thus have different steepness in different portions of the predefined time period 408a-408e, illustratively a different slope or rate of change. A power ramp 400a-400e have a first steepness in a first portion of the predefined time period 408a-408e and a second steepness in a second portion of the predefined time period 408a-408e, with the first steepness being different from the second steepness. As a further example, a power ramp 400a-400e have a third steepness in a third portion of the predefined time period 408a-408e, etc. For example, the first steepness may be lower than the second steepness, and the first steepness may be in the portion of the ramp corresponding to power values closer to the minimum power value 402a-402e than to the maximum power value 404a-404e.

Stated in a different fashion, a power ramp 400a-400e may be configured such that a difference between consecutive power values may have a first difference value in a first portion of the predefined time period 408a-408e and a second difference value in a second portion of the predefined time period 408a-408e, with the first difference value being different from the second difference value. As a further example, a power ramp 400a-400e have a third difference value in a third portion of the predefined time period 408a-408e, etc. For example, the first difference value may be less than the second difference value, and the first difference value may be in the portion of the ramp corresponding to power values closer to the minimum power value 402a-402e than to the maximum power value 404a-404e.

In a similar manner as the minimum and maximum power values, also the difference between consecutive power values in the ramp 400a-400e may be adapted depending on the desired application. Only as a numerical example, a difference between consecutive power values in the ramp 400a-400e may be in the range from 0.001% of the maximum power value 404a-404e to 10% of the maximum power value 404a-404e, for example in the range from 0.005% of the maximum power value 404a-404e to 5% of the maximum power value 404a-404e, for example in the range from 0.01% of the maximum power value 404a-404e to 1% of the maximum power value 404a-404e. As a numerical example, the minimum power value 402a-402e may be in the range from 0 to 1% of the maximum power value 404a-404e, for example in the range from 0.001% to 0.5% of the maximum power value 404a-404e, for example in the range from 0.003% to 0.1% of the maximum power value 404a-404e.

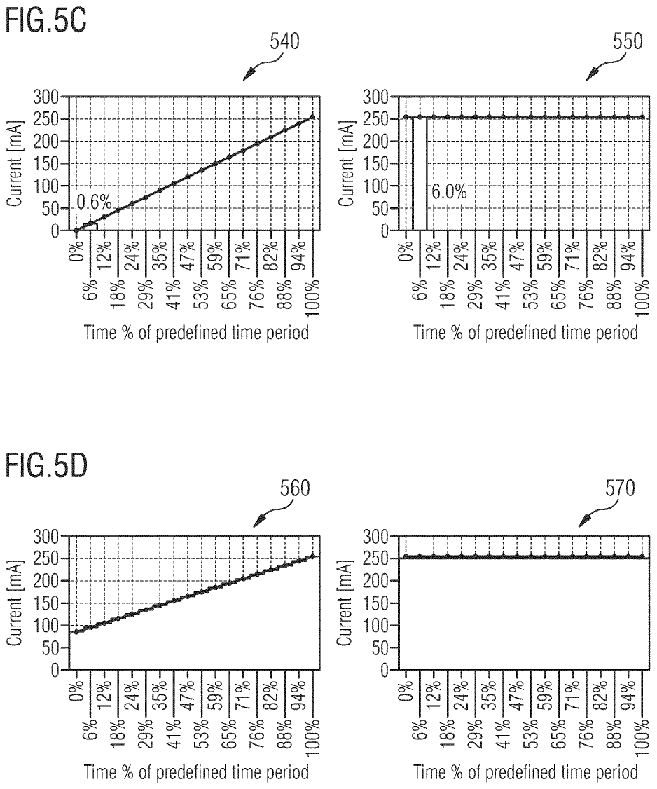

FIG. 5A to FIG. 5D show various graphs 500-570 illustrating the adapted driving scheme (FIG. 5A and FIG. 5B) and a comparison with pulse-width modulation (FIG. 5C and FIG. 5D). The graphs 500-570 refer to a current ramp with exemplary current values (from 0 to 250 mA), but it is understood that the aspects described in relation to FIG. 5A to FIG. 5D may apply in a corresponding manner to a voltage ramp.

The graph 500 in FIG. 5A shows an exemplary pulsed current delivery. As shown the pulsed powering of the load may be achieved by enabling the power delivery at some selected time points corresponding to some selected current values of the current ramp. The delivered current may thus be provided by the current values in correspondence of the time points at which the current delivery is enabled, e.g. the average current perceived by the load may be the result of the integral of the shaded parts under the ramp in the graph 500.

The graphs 510-530 in FIG. 5B show exemplary pulsed current deliveries, in which the current delivery is enabled for different % of the predefined time period, e.g. 25% in graph 510, 50% in graph 520, and 75% in graph 530, thus resulting in different “integrals” as defined by the shaded parts under the respective ramp in the graphs 510-530.

FIG. 5C and FIG. 5D show a comparison of the proposed scheme (in graphs 540 and 560) with PWM (in graphs 550 and 570). As shown in FIG. 5C, with conventional PWM, the smallest switchable time unit may be 6% of an image, thus corresponding to the classic PWM 6% in brightness. On the other hand, with the proposed current ramp the smallest switchable brightness level in the same time base may be smaller, e.g. 0.6%, thus allowing a finer resolution. This also accommodates the non-linear brightness perception of the eye where differences in low brightness are perceived more clearly than in high brightness. As shown in FIG. 5D, when using the full ramp the proposed approach may deliver less power compared to PWM, so that in some aspects conventional PWM may be combined with the proposed ramp to obtain a more flexible driving capable of adapting to higher power requirements.

A further advantage of the proposed configuration with respect to PWM may be illustrated with rough estimations about real world timings. For example, considering conventional PWM, at a 120 Hz framerate of display device (8 ms per frame) and at 15 bit brightness resolution, to obtain a share of 0.003% of brightness the switching needs to be carried out in a rather short time on the order of 300 ns. On the other hand, with the proposed ramp-approach, a 0.003% brightness step may be obtained already in 8 bit resolution, with a switching time of 33 μs only, thus 110 times slower than PWM and thus relaxing the system requirements.

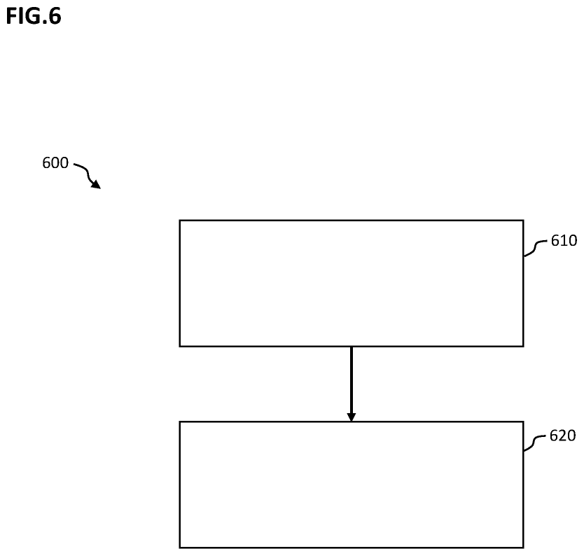

FIG. 6 shows a schematic flow diagram of a method 600 of powering a load, according to various aspects. It is understood that the aspects discussed in relation to the circuit 200 may apply in a corresponding manner to the method 600, and vice versa.

The method 600 may include, in 610, generating power according to a power ramp, such that during a predefined time period the generated power assumes a plurality of different power values in a range of power values from a minimum power value to a maximum power value. For example, the method 600 may include generating current according to a current ramp, such that during a predefined time period the generated current assumes a plurality of different current values in a range of current values from a minimum current value to a maximum current value. As another example, the method 600 may include generating voltage according to a voltage ramp, such that during a predefined time period the generated voltage assumes a plurality of different voltage values in a range of voltage values from a minimum voltage value to a maximum voltage value.

The method 600 may further include, in 620, selectively enabling or disabling a delivery of the generated power to a load during the predefined time period to deliver a predefined average power value to the load during the predefined time period. Illustratively, the method 600 may include selectively allowing or preventing a powering of the load by the power ramp such that the load perceives a predefined average power over the predefined time period. For example, the method 600 may include enabling or disabling a delivery of the generated power to a load during the predefined time period to deliver a predefined average current value or average voltage value to the load during the predefined time period.

As an example, the method 600 may include selectively connecting or disconnecting an electrically conductive path between the load and a power source. As another example, the method 600 may include selectively connecting a path between the load and a power source or a low resistance path that bypasses the load.

As an example, the method 600 may include selectively enabling or disabling a delivery of the generated power to a load including a light emitting element (e.g., a LED, a VCSEL, and the like) to obtain an average brightness value of emitted light over the predefined time period.

From another standpoint, the method 600 may include generating power according to a power ramp and delivering the generated power to a load. The method 600 may further include turning the load on and off (e.g., activating or deactivating the load) during the predefined time period according to an average power value to be perceived by the load during the predefined time period.

The terms “processor”, “processing circuit”, or “control circuit” as used herein may be understood as any kind of technological entity that allows handling of data. The data may be handled according to one or more specific functions that the processor/processing circuit/control circuit may execute. Further, a processor/processing circuit/control circuit as used herein may be understood as any kind of circuit, e.g., any kind of analog or digital circuit. A processor/processing circuit/control circuit may thus be or include an analog circuit, digital circuit, mixed-signal circuit, logic circuit (e.g., a hard-wired logic circuit or a programmable logic circuit), microprocessor, Central Processing Unit (CPU), Graphics Processing Unit (GPU), Digital Signal Processor (DSP), Field Programmable Gate Array (FPGA), integrated circuit, Application Specific Integrated Circuit (ASIC), etc., or any combination thereof. It is understood that any two (or more) of the processors/processing circuits/control circuits detailed herein may be realized as a single entity with equivalent functionality or the like, and conversely that any single processor/processing circuit/control circuit detailed herein may be realized as two (or more) separate entities with equivalent functionality or the like.

The term “connected” may be used herein with respect to terminals, integrated circuit elements, devices, and the like, to mean electrically connected, which may include a direct connection or an indirect connection, wherein an indirect connection may only include additional structures in the current path that do not influence the substantial functioning of the described circuit or device. The term “electrically conductively connected” that is used herein to describe an electrical connection between one or more terminals, devices, regions, contacts, etc., may be understood as an electrically conductive connection with, for example, ohmic behavior, e.g. provided by a metal or degenerate semiconductor in absence of p-n junctions in the current path. The term “electrically conductively connected” may be also referred to as “galvanically connected”. The term “coupled” may be used herein in the same manner as the term “connected”.

The term “terminal” may be used herein to describe a location (e.g., a point) or structure of a device or of an element of the device at which a signal (e.g., an analog signal, for example a current or a voltage) may be provided and/or to which another device or element may be connected. Illustratively, a terminal may be a location or a structure that is electrically conductively connected with the device or the element. A terminal may also be referred to herein as port, pin, contact, or contact point.

The word “exemplary” is used herein to mean “serving as an example, instance, or illustration”. Any embodiment or design described herein as “exemplary” is not necessarily to be construed as preferred or advantageous over other embodiments or designs.

The phrase “at least one” and “one or more” may be understood to include a numerical quantity greater than or equal to one (e.g., one, two, three, four, [ . . . ], etc.). The phrase “at least one of” with regard to a group of elements may be used herein to mean at least one element from the group consisting of the elements. For example, the phrase “at least one of” with regard to a group of elements may be used herein to mean a selection of: one of the listed elements, a plurality of one of the listed elements, a plurality of individual listed elements, or a plurality of a multiple of individual listed elements.

All acronyms defined in the above description additionally hold in all claims included herein.

While the invention has been particularly shown and described with reference to specific aspects, it should be understood by those skilled in the art that various changes in form and detail may be made therein without departing from the spirit and scope of the invention as defined by the appended claims. The scope of the invention is thus indicated by the appended claims and all changes, which come within the meaning and range of equivalency of the claims, are therefore intended to be embraced.

List of reference signs

| | |
|---|---|
| 110 | Graph |
| 120 | Graph |
| 130 | Graph |
| 200 | Circuit |
| 200b | Circuit configuration |
| 200c | Circuit configuration |
| 202 | Power source |
| 204 | Power ramp |
| 206 | Supply terminal |
| 208 | Output terminal |
| 210 | Switchable element |
| 212 | Control circuit |
| 214 | Load |
| 302 | Load |
| 304 | Load element |
| 306 | Switchable element |
| 308 | Switchable element |
| 312 | Load |
| 314 | Light emitting element |
| 400a | Power ramp |
| 400b | Power ramp |
| 400c | Power ramp |
| 400d | Power ramp |
| 400e | Power ramp |
| 402a | Minimum value |
| 402b | Minimum value |
| 402c | Minimum value |
| 402d | Minimum value |
| 402e | Minimum value |
| 404a | Maximum value |
| 404b | Maximum value |
| 404c | Maximum value |
| 404d | Maximum value |
| 404e | Maximum value |
| 406a | Intermediate values |
| 406b | Intermediate values |
| 406c | Intermediate values |
| 406d | Intermediate values |
| 406e | Intermediate values |
| 408a | Predefined time period |
| 408b | Predefined time period |
| 408c | Predefined time period |
| 408d | Predefined time period |
| 408e | Predefined time period |
| 500 | Graph |
| 510 | Graph |
| 520 | Graph |
| 530 | Graph |
| 540 | Graph |
| 550 | Graph |
| 560 | Graph |
| 570 | Graph |
| 600 | Method |
| 610 | Method step |
| 620 | Method step |

1. A circuit comprising:
an output terminal configured to be coupled with a load;
a power source configured to generate current according to a current ramp,
such that during a predefined time period the generated current assumes a plurality of different current values in a range of current values from a minimum current value to a maximum current value;
a switch element configured to selectively enable or disable a delivery of the generated current to the output terminal; and
a control circuit configured to control the switch element to deliver a predefined average current value at the output terminal over the predefined time period.

2. The circuit according to claim 1,
wherein the current ramp comprises the minimum current value, the maximum current value, and one or more intermediate current values between the maximum current value and the minimum current value.

3. The circuit-according to claim 1,
wherein the current ramp is configured such that the current values of the generated current vary in a monotonic manner in the range of current values.

4. The circuit according to claim 1,
wherein the current ramp is configured such that the current values of the generated current decrease from the maximum current value to the minimum current value over the predefined time period; or
wherein the current ramp is configured such that the current values of the generated current increase from the minimum current value to the maximum current value over the predefined time period.

5. The circuit according to claim 1,
wherein the current ramp has a first steepness in a first portion of the predefined time period and a second steepness in a second portion of the predefined time period,
wherein the first steepness is different from the second steepness.

6. The circuit-according to claim 1,
wherein the predefined time period comprises a plurality of time intervals, and
wherein the current ramp is configured such that during each time interval the generated current assumes a respective current value within the range of current values, and
wherein the control circuit is configured to control the switch element to enable the delivery of current to the output terminal during a number of first time intervals and to disable the delivery of current to the output terminal during a number of second time intervals according to the average current value to be delivered to the output terminal over the predefined time period.

7. The circuit according to claim 1, further comprising:
a further power source configured to generate a further current having a fixed value; and
a further switch element configured to selectively enable or disable a delivery of the generated further current to the output terminal; and
wherein the control circuit is further configured to control the further switch element to deliver a predefined further average current value to the output terminal.

8. The circuit according to claim 1, further comprising:
the load coupled with the output terminal.

9. The circuit according to claim 8,
wherein the load comprises a plurality of load elements,
wherein the switch element comprises a plurality of switch elements,
wherein each switch element is configured to selectively enable or disable a delivery of the generated current to one or more load elements of the plurality of load elements, and
wherein the control circuit is configured to control the switch elements to deliver a respective predefined average current value to the respective one or more load elements during the predefined time period.

10. The circuit according to claim 9,
wherein the power source is common to all load elements of the plurality of load elements.

11. The circuit according to claim 8,
wherein the load comprises one or more light emitting elements configured to be driven by the current delivered by the power source, and
wherein the control circuit is configured to control the switch element to obtain a predefined brightness value for light emitted by the one or more light emitting elements during the predefined time period.

12. The circuit according to claim 11,
wherein at least one current value of the range of current values is greater than the maximum driving current rated for at least one light emitting element of the one or more light emitting elements.

13. A circuit comprising:
a power source configured to:
generate electrical power according to a power ramp and
deliver the generated electrical power to a load,
such that during a predefined time period the power delivered to the load assumes a plurality of different power values in a range of power values from a minimum power value to a maximum power value; and
a control circuit configured to turn the load on and off during the predefined time period according to an average power value to be perceived by the load during the predefined time period.

14. A method of powering a load, the method comprising:
generating current according to a current ramp, such that during a predefined time period the generated current assumes a plurality of different current values in a range of current values from a minimum current value to a maximum current value; and
selectively enabling or disabling a delivery of the generated current to the load during the predefined time period to deliver a predefined average current value to the load over the predefined time period.

15. (canceled)

16. The method according to claim 14,
wherein the current ramp comprises the minimum current value, the maximum current value, and one or more intermediate current values between the maximum current value and the minimum current value.

17. The method according to claim 14,
wherein the current values of the generated current vary in a monotonic manner in the range of current values.

18. The method according to claim 14,
wherein the current values of the generated current decrease from the maximum current value to the minimum current value over the predefined time period; or
wherein the current values of the generated current increase from the minimum current value to the maximum current value over the predefined time period.

19. The method according to claim 14,
wherein the current ramp has a first steepness in a first portion of the predefined time period and a second steepness in a second portion of the predefined time period,
wherein the first steepness is different from the second steepness.

20. The method according to claim 14,
wherein the predefined time period comprises a plurality of time intervals,
wherein, during each time interval, the generated current assumes a respective current value within the range of current values, and
wherein the method further comprises enabling the delivery of current to the load during a number of first time intervals and disabling the delivery of current to the load during a number of second time intervals according to the average current value to be delivered to the load over the predefined time period.

21. The method according to claim 14,
wherein the load comprises one or more light emitting elements driven by the generated current, and
wherein the method comprises selectively enabling or disabling a delivery of the generated current to the load to obtain a predefined brightness value for light emitted by the one or more light emitting elements during the predefined time period.
